(19) United States
(12) Patent Application Publication
(10) Pub. No.: US 2002/0018913 A1
(43) Pub. Date: Feb. 14, 2002

(54) Magneto-optical body and optical isolator using the same

(75) Inventors: Hideki Kato, Iwata-gun (JP); Mitsuteru Inoue, Okazaki-shi (JP); Akio Takayama, Itawa-gun (JP)

Correspondence Address: OLIFF & BERRIDGE, PLC, P.O. BOX 19928, ALEXANDRIA, VA, 22320, US

(73) Assignee: Minebea Co., Ltd., Kitasaku-gun (JP)

(21) Appl. No.: 09/918,439

(22) Filed: Aug. 1, 2001

(30) Foreign Application Priority Data
Aug. 2, 2000 (JP) 2000-234461

(51) Int. Cl. B32B 15/00; B32B 9/00; B32B 19/00

(52) U.S. Cl. 428/692; 428/641

(57) ABSTRACT

A magneto-optical body with a reduced manufacturing cost and an improved yield and an optical isolator using the same are provided. The magneto-optical body includes two dielectric multilayered films each consisting of a Si thin film having a refractive index (Ms) of 3.11 and a SiO₂ thin film having a refractive index (Mt) of 1.415 and provided at both sides of a magnetic thin film. By using the dielectric multilayered films each comprising two types of dielectric thin films having a refractive index largely different from each other, light is intensely localized at the center. A great magneto-optical effect may be obtained and a large Faraday rotation angle may be obtained with a reduced number of layers of the dielectric thin films. A manufacturing cost is reduced, and process control also is relaxed, thereby improving a manufacturing yield.

### BACKGROUND OF THE INVENTION

1. Field of the Invention

The present invention relates to a magneto-optical body, and further to an optical isolator employing the magneto-optical body and used in an optical fiber communication system, an optical measuring system and so forth.

2. Description of the Related Art

In an optical fiber communication system having a semiconductor laser as a light source, in particular, a high-speed digital transmission or analog direct modulation type optical system, reflection noise often causes serious problems in designing systems and devices. The reflection noise is generated by reflected light which comes from connecting points of optical connectors, optical circuit components or the like used in an optical fiber circuit and reenters laser. In this case, an optical isolator is used in order to remove the reflected light that has reentered laser. As basic functions, an optical isolator transmits light emitted from a semiconductor laser (light source) to a transmission line, such as an optical fiber, without loss, and cuts off reflected light from the optical fiber or the like to prevent the light from returning to the semiconductor laser (light source).

An optical isolator for use in an optical fiber communication system employs the Faraday effect (magneto-optical effect) to rotate polarization plane of incident light 45 degrees. The optical isolator transmits light emitted from a light source, such as a semiconductor laser, to a transmission line without loss and cuts off reflected light from the transmission line to prevent the light from returning to the light source.

A conventional optical isolator for communication generally has a polarizer, an analyzer, and a magneto-optical body that has the Faraday effect (magneto-optical effect) and is provided between the polarizer and the analyzer.

FIGS. 11, 12A and 12B show the structure and the operation principles of an optical isolator for communication. An optical isolator for communication shown in FIG. 11 is generally composed of a polarizer 2A, an analyzer 2B, a Faraday rotator 1 (Faraday element, magneto-optical element, magneto-optical body) that is provided between the polarizer 2A and the analyzer 2B and rotates the plane of polarization of light by 45 degrees, and permanent magnets 3 for applying a magnetic field.

Incident light 101 traveling in a forward direction shown in FIG. 12A is not polarized. After through the polarizer 2A, the light is composed only of a component in the polarization direction of the polarizer 2A, as represented by light 102. Then, the light 102 passes through the Faraday rotator 1, and the polarization direction thereof is rotated by 45 degrees, thus constituting light 103. If the polarization direction of the analyzer 2B is adjusted to agree with the polarization direction of the light 103 rotated by 45 degrees, the light 103 passes through the analyzer 2B with minimal loss. On the other hand, as shown in FIG. 12B, among reflected light 105 traveling in a backward direction from an optical fiber or the like only a component 106 oriented in the polarization direction of the analyzer 2B passes through the analyzer 2B. The light is then made incident on the Faraday rotator 1 in the backward direction. The light is rotated by 45 degrees in the same direction as in case of the forward direction by the non-reciprocal property that is unique to the Faraday effect. Accordingly, after passing through the Faraday rotator 1, the light changes into light 107 that is orthogonal to the polarization direction of the polarizer 2A and is cut off so as not to return to the light source.

A magneto-optical element as the Faraday rotator includes a single crystal thick film that is gained by thickening, by liquid phase epitaxial (LPE) growth, a material having a relatively high particular magneto-optical effect, such as yttrium iron garnet (YIG) or bismuth-substituted rare earth iron garnet (BiYIG), on a GGG (gadolinium-gallium-garnet) single crystal substrate. However, this single crystal thick film has to be thick to ensure the Faraday rotation angle of 45 degrees that is required to carry out a function when used as, for instance, an optical isolator, which inevitably leads to an increase in dimension. This also increases light absorption loss (deterioration in transmissivity).

Furthermore, many control parameters are required for the liquid phase epitaxial (LPE) growth, and the manufacturing technique is not established good enough to obtain a thick film. Furthermore, in order to provide 45-degree rotary polarization, a thick film grown by the liquid phase epitaxial (LPE) growth must be polished precisely to a predetermined thickness, where the firm thickness of Bi-substituted rare earth iron garnet is several hundred μm and therefore a strict machining accuracy is required. There is also a problem in that a GGG single crystal wafer for a substrate is extremely expensive.

In consideration of the above-noted problems of a magneto-optical element by the LPE, the present inventors have proposed an optical isolator, which is composed of a polarizer, an analyzer and a magneto-optical body that is constructed to utilize an optical enhancement effect of a magneto-optical film so as to improve the magneto-optical effect

The magneto-optical body is constructed by laminating magnetic substance and dielectric substance into a thin film with each substance layer irregular in thickness or by comprising two dielectric multilayered films in each of which two types of dielectric substances having different optical characteristics from each other are alternately laminated with each thereof regular in thickness and a center film which is comprised of magnetic substance and provided between the two dielectric multilayered films. In this case, as a polarizer and an analyzer, a calcite Rochon prism, a wedge-shaped rutile single crystal, polarization beam splitter (PBS), or the like is used.

FIG. 13 shows one embodiment of a magneto-optical body that is constructed to utilize the optical enhancement effect and is employed for the optical isolator proposed by the present inventors. This magneto-optical body 200 is of a multilayered film (SiO₂/Ta₂O₅)ⁿ/BiYIG/(Ta₂O₅/SiO₂)ⁿ(n is the number of lamination) in which bismuth-substituted rare earth iron garnet (BiYIG) (magneto-optical thin film 207) is provided at the center and a laminated film of (SiO₂/Ta₂O₂)ⁿ(dielectic multilayered film 210) and a laminated film of (Ta₂O₅/SiO₂)ⁿ (dielectric multilayered film 211) are provided at both sides of the magneto-optical in film 207, respectively.

FIG. 14 shows the light transmissivity and the wavelength characteristics of Faraday rotation angle of a magneto-optical body of a multilayered film structured as (SiO₂/Ta₂O₅)¹²/BiYIG/(Ta₂O₅/SiO₂)¹². The Faraday rotation angle at a wavelength of 1300 mn is 32° and the total number of laminations in the multilayered film is 49. In order to increase the Faraday rotation angle up to 45°, the number of laminations must be increased. As the number of laminations increases, the manufacturing cost increases, and also process control becomes difficult, lowering a manufacturing yield. Thus, characteristics and a manufacturing yield of an isolator using such a magneto-optical body incur deterioration.

### SUMMARY OF THE INVENTION

Accordingly, it is an object of the present invention to overcome the conventional problems described above.

According to a first aspect of the present invention, in a magneto-optical body which consists of two dielectric multilayered films in each of which two types of dielectric thin films having different optical characteristics from each other are alternately laminated with each thereof regular in thickness and a magnetic thin film provided between the two dielectric multilayered films, one dielectric thin film of the two types has a refractive index different from the refractive index of other dielectric thin film.

According to a second aspect of the present invention, in a magneto-optical body as described in the fist aspect, the refractive index of the one dielectric thin film may be tree or higher, and the refractive index of the other dielectric thin film may be less than three.

According to a third aspect of the present invention, in a magneto-optical body as described in the second aspect, the one dielectric thin film may be Si, and the other dielectric thin film may be SiO₂.

According to a fourth aspect of the present invention, an optical isolator employs the magneto-optical body as described in any one of the first to third aspects of the present invention.

### BRIEF DESCRIPTION OF THE DRAWINGS

FIG. 1 is a cross-sectional view showing a magneto-optical boxy of a first embodiment of the present invention;

FIG. 2 is a characteristic diagram showing transmission wavelength spectrums and Faraday rotation angles of the magneto-optical body of the present invention;

FIG. 3 is a diagram showing a photonic band gap of optical crystals;

FIG. 4 is a diagram showing the pattern of a standing wave of the magneto-optical body;

FIG. 5 is a diagram showing relations between strongly localized wavelengths and transmissivity;

FIG. 6 is a diagram showing the manufacturing process of the magneto-optical body in FIG. 1;

FIG. 7 is a diagram showing how each member is set and an infrared-ray introducing heater in the manufacturing process of PIG. 6;

FIG. 8 is a diagram showing a thermal treatment pattern in the manufacturing process of FIG. 6;

FIG. 9 is a diagram showing a second embodiment of the present invention;

FIG. 10 is a diagram showing an optical isolator relating to a third embodiment of the present invention;

FIG. 11 is a diagram showing one embodiment of a conventional optical isolator;

FIG. 12A and FIG. 12B are diagrams showing the operation principles of the optical isolator;

FIG. 13 is a cross-sectional view showing a conventional magneto-optical body; and

FIG. 14 is a diagram showing the transmissivity and Faraday rotation angles of a magneto-optical body.

### DESCRIPTION OF THE PREFERRED EMBODIMENT

The present inventors discovered that light is more strongly localized at the center (center film) of a magneto-optical body which has two dielectric multilayered films in each of which two types of dielectric thin alms having different optical characteristics from each other are alternate laminated with each thereof regular in thickness and a magnetic thin film provided between the two dielectric multilayered films when the refractive index of one dielectric thin film of the two types is set large and the refractive index of other dielectric thin film is set small so as to provide a largest difference possible in refractive index between the two types of dielectric thin films. Because of the stronger localization of light, a large Faraday rotation angle can be obtained without so much increasing the number of the laminations of the dielectric multilayered films.

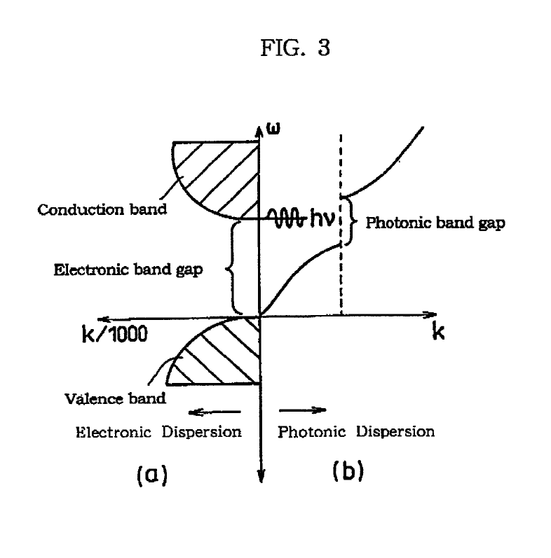

Before the embodiments of the present invention are described the physical theory of the magneto-optical body will be explained. The magneto-optical body has a wavelength region where light cannot propagate in a certain direction like an electron crystal has a band gap at an energy level. This specific wavelength region is called a photonic band gap and varies depending on multilayer film structures FIG. 3 shows a photonic band gap (b) in comparison with an electron state (a).

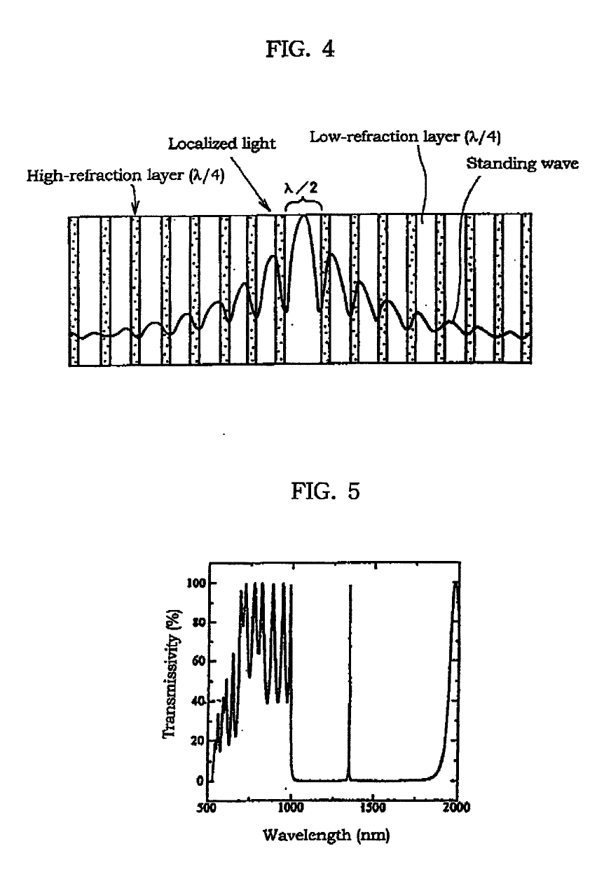

Disarrangement at one part of a periodic structure of magneto-optical bodies is equivalent to a defect in electron crystals, whereby light having a specific wavelength in a photonic band gap is transmitted therethrough. The distribution of a standing wave of the magneto-optical body is shown in FIG. 4. In the magneto-optical body shown in FIG. 4, light is strongly localized at the center thereof, which results in unique transmission properties and a great magneto-optical effects Additionally, it was found that tansmissivity is high at a wavelength where light is strongly localized, as shown in FIG. 5.

When light having a specific wavelength is made incident on a magneto-optical body to be described below, the light is strongly localized, and a great magneto-optical effect and a high transmissivity are obtained. The above mentioned magneto-optical body, for instance, has two dielectric multilayered films (for example, laminated film of SiO₂/Si in which the refractive index (Mt) of SiO₂ is smaller than the refractive index (Ms) of Si and each of thickness Dt and Ds satisfies Ms·Ds=Mt·Dt=λ/4.), in which two kinds of dielectric materials having different optical characteristics from each other are alternately laminated with each thereof rear in thickness and a magnetic thin film (the thickness thereof is, for instance, λ or λ/2) provided between the two dielectric multilayered films.

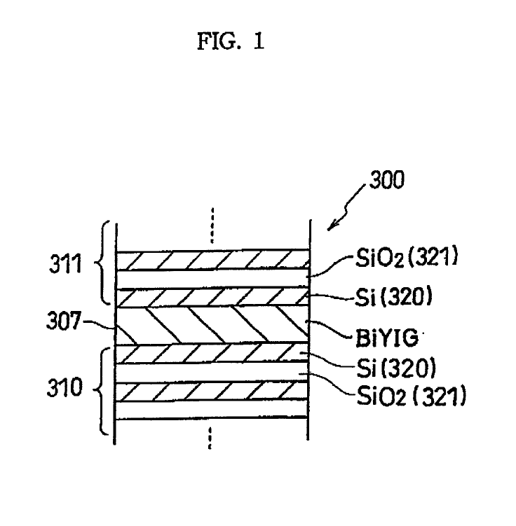

A magneto-optical body 300 relating to a first embodiment of the present invention will be explained below based on FIG. 1. The magneto-optical body 300 has a resonance wavelength of 1.31 μm. As a center film (magnetic thin film 307), a (BiY)₃Fe₅O₁₂ garnet film (hereinafter simply referred to as BiYIG film) is used, and as two dielectic multilayered films 310, 311, n layers of laminated films each consist of a Si film 320 (one dielectric thin film) and a SiO₂ film 321 (other dielectric thin film) are used and provided at both sides of the center film, respectively.

The dielectric multilayered films 310, 311 of the magneto-optical body 300 are symmetric with respect to the center film (magnetic thin film 307). Each dielectric film has a thickness of (wavelength (λ) of incident light)/(4×refractive index (M) of dielectric), and is alternately laminated. In other words, the dielectric multilayered films are laminated with each thereof regular in thickness. The thickness of the SiO₂ film 321 is [1310/(4×1.415)]=231 nm, and the thickness of the Si film 320 is [1310/(4×3.11)]=105 nm. And, the thickness of the center layer, that is the BiYIG film 307, does not follow the regularity in the thickness of the multilayered films 310, 311 and measures 298 nm (λ/2 as magnetic film thickness). The wavelength (λ) of incident light is 1310 nm; the refractive index (Ms) of the Si film 320 (one dielectic thin film) is 3.11; the refractive index (Mt) of the SiO₂ film 321 (other dielectric thin film) is 1.415; and the refractive index (Nm) of the BiYIG film 307 is 2.19.

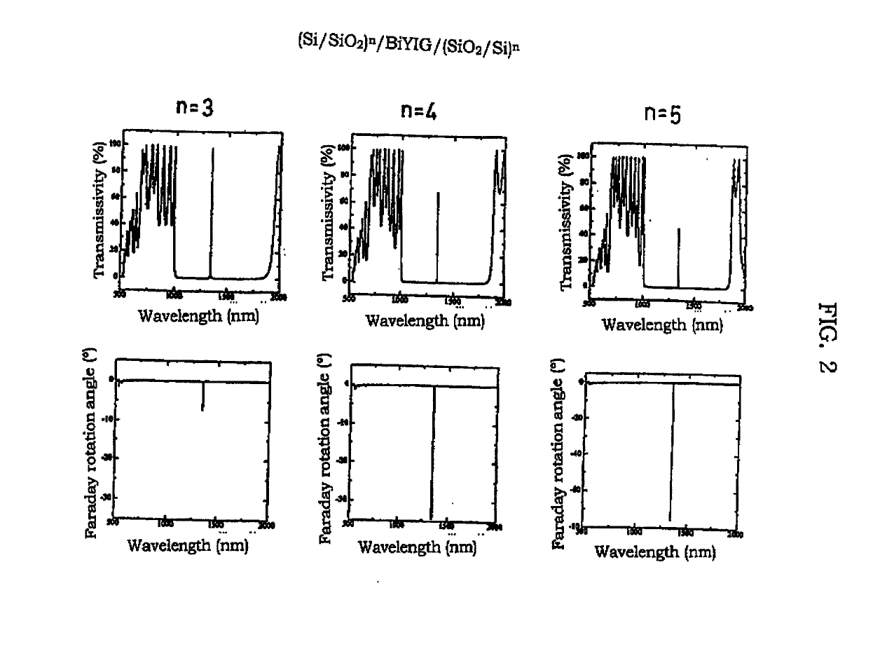

For the magneto-optical body of a multilayered film (Si/SiO₂)ⁿ/BiYIG/(SiO₂/Si)ⁿ, specifically, the magneto-optical body 300 at n×3, 4 and 5, the change in transmissivity and the Faraday rotation angles (θ_{F}) relative to the wavelength of incident light are examined. In FIG. 2, the vertical axes indicate the transmissivity or the Faraday rotation angles (θ_{F}), and the horizontal axes indicate the wavelengths (λ) of incident light. As clearly seen from FIG. 2, the transmissivity and the Faraday rotation angles (θ_{F}) have peaks at around 1310 nm of the wavelength (λ).

For the magneto-optical body of the present embodiment and the magneto-optical body of the above described multilayered film (SiO₂/Ta₂O₅)¹²/BiYIG/(Ta₂O₅/SiO₂)¹², each transmissivity and Faraday rotation angle are compared herein.

In the magneto-optical body 300 of this embodiment, refractive indexes of the two kinds of dielectric thin films (Si film 320 and SiO₂ film 321) are set substantially different from each other (the refractive index (Ms) of the Si film 320 is 3.11, and the refractive index (Mt) of the SiO₂ film 321 is 1.415) whereby light is localized strongly at the center thereof and a great magneto-optical effect is obtained. Accordingly, large Faraday rotation angles are obtained with a small number of laminations, e.g. thirteen layers at n=3; 17 layers at n=4; and 21 layers at n=5.

Since a large Faraday rotation angle can be gained with a reduced number of the layers of the dielectric thin films, a manufacturing cost may be reduced. Additionally, process control becomes relatively easy, thus improving a manufacturing yield. Furthermore, the characteristics and manufacturing yield of an optical isolator using the magneto-optical body 300 may improve.

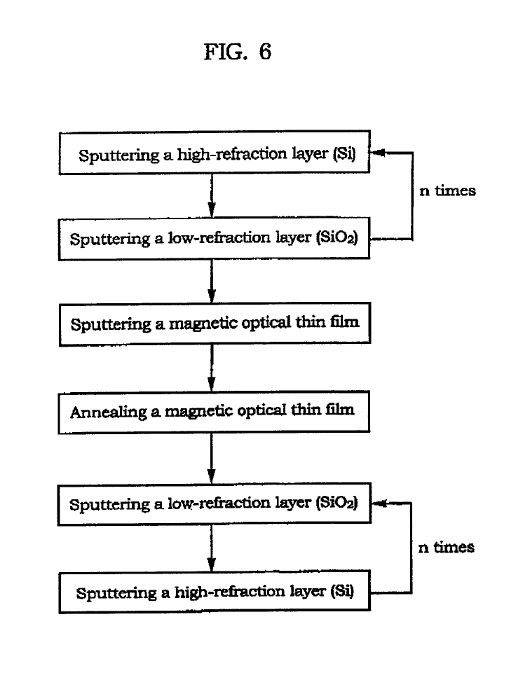

Now, the magneto-optical body of the embodiment of the present invention and the manufacturing method thereof will be explained based on FIG. 6. On a substrate, such as a glass, having a preferable light transmission property at working wavelengths, a thin film with a thickness of λ/4 having a high refractive index (for instance, Si thin film) is formed, then a thin film with a thickness of λ/4 having a low refractive index (for example, SiO₂ thin film) is formed. This procedure is repeated n times. Then a bismuth-substituted rare earth iron garnet film (BiYIG thin film) is formed. The bismuth-substituted rare earth iron garnet film is amorphous right after sputtering and has no magnetism, so crystallization by a high-temperature thermal treatment is required. To this end, annealing is performed. Furthermore, a thin film with a thickness of λ/4 having a low refractive index (for instance, SiO₂ thin film) is formed, then a thin Em with a thickness of λ/4 having a high refractive index (for example, Si thin film) is formed. This procedure is repeated n times, thus forming the magneto-optical body of (Si/SiO₂)ⁿ/BiYIG/(SiO₂/Si)ⁿ of the present invention.

Moreover, the magneto-optical body of (SiO₂/Si)ⁿ/BiYIG/(Si/SiO₂)ⁿ may be similarly formed by reversing the order of the Si thin film and the SiO₂ thin film, that is forming, first a thin film with a thickness of λ/4 having a low refractive index (for instance, SiO₂ thin film) on a substrate, then a thin film with a thickness of λ/4 having a high refractive index (for example, Si thin film).

As described above, the bismuth-substituted rare earth iron garnet film is amorphous right after sputtering and has no magnetism, and therefore has to be crystallized by a high-temperature thermal treatment. On the other hand, the periodic structure of the dielectric multilayered films is disarranged (damaged) by the high-temperature thermal treatment. Thus, it has been practically very difficult to manufacture the magneto-optical body using the bismuth-substituted rare earth iron garnet.

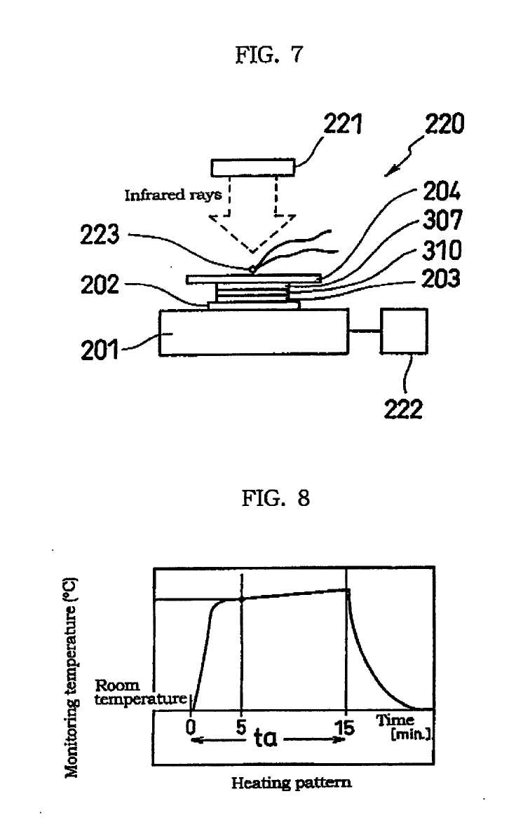

In the embodiment, as shown in FIG. 7, an indium sheet 202 is placed on a water-cooled substrate holder 201, and a substrate (for instance, quartz glass) 203 is placed on the indium sheet 202. A glassy carbon 204 is set as a condensing plate on the substrate 203.

A (SiO₂/Si)ⁿ film 310 (one dielectric multilayered film of the two, where n is the number of laminations), in which a SiO₂ layer (dielectric material) and a Si layer (dielectric material) having different optical characteristics from each other shown in FIG. 1 are alternately laminated with each thereof regular in thickness, is laid on the substrate 203. The SiO₂ layer (dielectric material) and the Si layer (dielectric material) are formed of a material that is transparent in an infrared ray region and has a high environmental stability. As the substrate 203, it is desirable to use a material that does not melt during the crystallization thermal treatment of the BiYIG thin film 307 by an infrared-ray introducing heater 220.

The BiYIG thin film 307 (bismuth-substituted rare earth iron garnet) is then formed on the (SiO₂/Si)ⁿ film 310 and subjected to the crystallization thermal treatment by the infrared-ray introducing heater 220 as described below. Subsequently, on (SiO₂/Si)ⁿ/BiYIG containing the crystallized BiYIG thin film 307, a (Si/SiO₂) a film 311 (other dielectric multilayered film of the two) is formed, thus forming the magneto-optical body 300 of (SiO₂/Si)ⁿ/BiYIG/(Si/SiO₂)ⁿ shown in FIG. 1. The magneto-optical body 300 was formed by a multi-target RF magnetron sputtering device, but may be formed alternatively by evaporation or CVD (chemical vapor deposition).

The infrared-ray introducing heater 220, as shown in FIG. 7, has an infrared-ray generator 221 to generate infrared beams, the glassy carbon 204 to condense the infrared beams, a cooling mechanism 222 to cool the substrate holder 201, and a thermocouple 223 that is arranged directly on a surface of the glassy carbon 204 during heating and is used for monitoring temperature.

During the crystallization thermal treatment of the BiYIG thin film 307 by the infrared-ray introducing heater 220, the substrate holder 201 is cooled, thereby cooling the (SiO₂/Si)ⁿ layer 310 through the substrate 203.

On the other hand, during the thermal treatment only the BiYIG thin film 307 is heated by the glassy carbon 204 that is heated by infrared rays and crystallized. In this case, infrared beams are intermittently irradiated (pulse heating).

Since the (SiO₂/Si)ⁿ film 310 is cooled as described above, the Si and SiO₂ of the (SiO₂/Si)ⁿ film 310 are prevented from mutually diffusing. Accordingly, the periodic structure of the (SiO₂/Si)ⁿ film 310 is not disarranged, while the BiYIG thin film 307 is crystallized by the thermal treatment, resulting in that the magneto-optical body 300 having superior magneto-optical characteristics is manufactured.

In this embodiment, the (SiO₂/Si)ⁿ film 310 is cooled through the substrate 203, but the (SiO₂/Si)ⁿ film 310 may be directly cooled. During the thermal treatment by the infrared-ray introducing heater 220, the thermocouple 223 was placed in contact with the surface of the glassy carbon 204 for monitoring temperature. FIG. 8 shows the thermal treatment pattern. When the crystallization thermal treatment was carried out by such heating method, the BiYIG thin film 307 which was amorphous right after the formation was crystallized at a thermal treatment temperature of 850° C. and the Faraday rotation angle showed the same value as gained when heated and crystallized by a conventional electric furnace. Additionally, no surface roughening or cracks were found on the BiYIG thin film 307.

(SiO₂/Si)ⁿ/BiYIG was treated by the same heating met, and (Si/SiO₂)ⁿ was formed thereon, thus manufacturing a magneto-optical body of (SiO₂/Si)ⁿ/BiYIG/(Si/SiO₂)ⁿ, and as a comparison purpose another magneto-optical body of (SiO₂/Si)ⁿ/BiYIG/(Si/SiO₂)ⁿ was manufactured without the thermal treatment Then, the transmission spectrums of each magneto-optical body were examined.

In case of the magneto-optical body with no thermal treatment, a photonic band gap appeared in a wavelength region of λ=1000 to 1800 nm, and a sharp wavelength peak also appeared at λ=1310 nm. Also in case of the magneto-optical body with the heating treatment of the embodiment, a photonic band gap appeared in a wavelength region of λ=1000 to 1800 nm, and a sharp wavelength peak also appeared at λ=1310 nm. Thus, the waveforms of the transmission spectrums showed almost no difference between the magneto-optical body with no thermal treatment and the magneto-optical body of the embodiment of the present invention. This indicates that the periodic structure of the multilayered film of (SiO₂/Si)ⁿ/BiYIG/(Si/SiO₂)ⁿ is hay changed under the conditions of the thermal treatment that is to crystallite the BiYIG thin film 307 with the irradiation of infrared rays by the infrared-ray introducing heater 220.

For the magneto-optical body of (SiO₂/Si)ⁿ/BiYIG/(Si/SiO₂)ⁿ that was manufactured by forming (Si/SiO₂)ⁿ on heat-treated (SiO₂/Si)ⁿ/BiYIG as mentioned above, a Faraday rotation angle was examined. According to the results (not shown), it was realized that the magneto-optical body 300 has a large Faraday rotation angle. Since infrared beams are intermittently irradiated (pulse heating) in the embodiment, the BiYIG thin film 307 may be crystallized more precisely.

Moreover, since the glassy carbon 204 condenses infrared beams, the thermal treatment is carried out quickly. The thermal treatment may be performed without providing the glassy carbon 204.

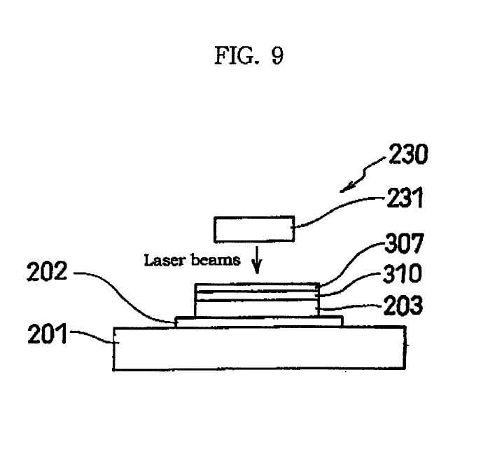

In the embodiment, the BiYIG thin film 307 is crystallized by infrared beams from the infrared-ray introducing heater 220. However, the BiYIG thin film 307 may be crystallized by laser beams instead, as shown in FIG. 9 (second embodiment).

In this second embodiment, the substrate 203 is set on the substrate holder 201 while the face thereof having (SiO₂/Si)ⁿ/BiYIG formed is placed upward Laser beams from a laser beam source 231 are irradiated on the (SiO₂/Si)ⁿ/BiYIG, thus crystallizing the BiYIG thin film 307.

Moreover, since laser beams are intermittently irradiated (pulse heating), the BiYIG thin film 307 may be crystallized more precisely.

The cooling mechanism 222 and the cooling treatment that are required in the first embodiment described above (FIG. 7) are unnecessary in the second embodiment. Accordingly, the composition is simplified and cooling operation is eliminated thereby increasing productivity.

The magneto-optical body 300 in the two embodiments mentioned above has a great Faraday effect as described above, and can perform well when used in various optical devices such as an optical isolator.

In the present embodiments (the first and second embodiments), the BiYIG thin film 307 is used. However, the present invention is not limited to this film, and other rare ea iron garnet thin films may be applied. Also, Ge (refractive index is 4.1), which is transparent in an infrared region, may be used in place of Si.

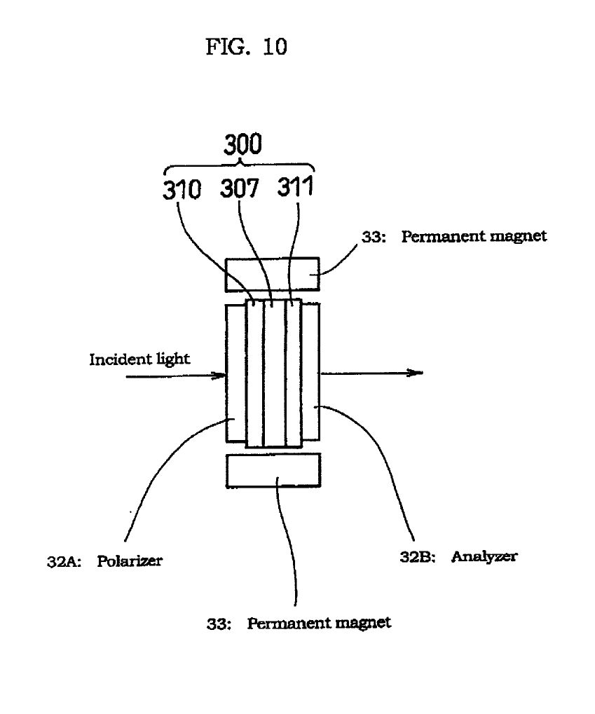

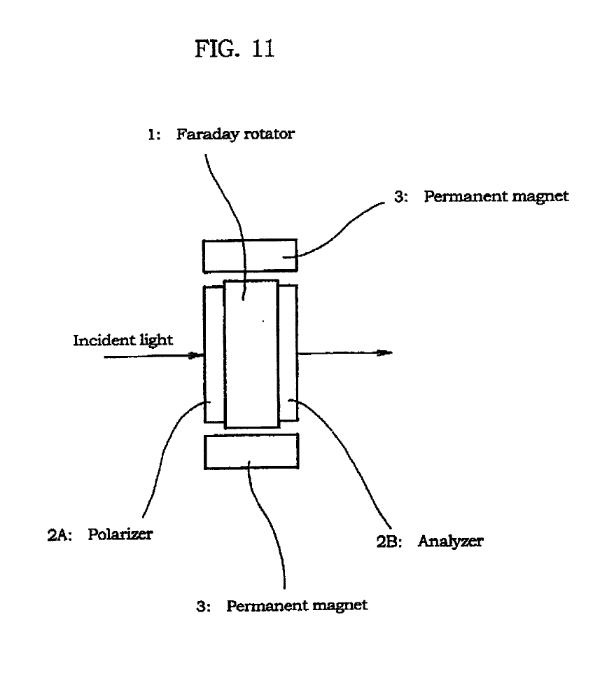

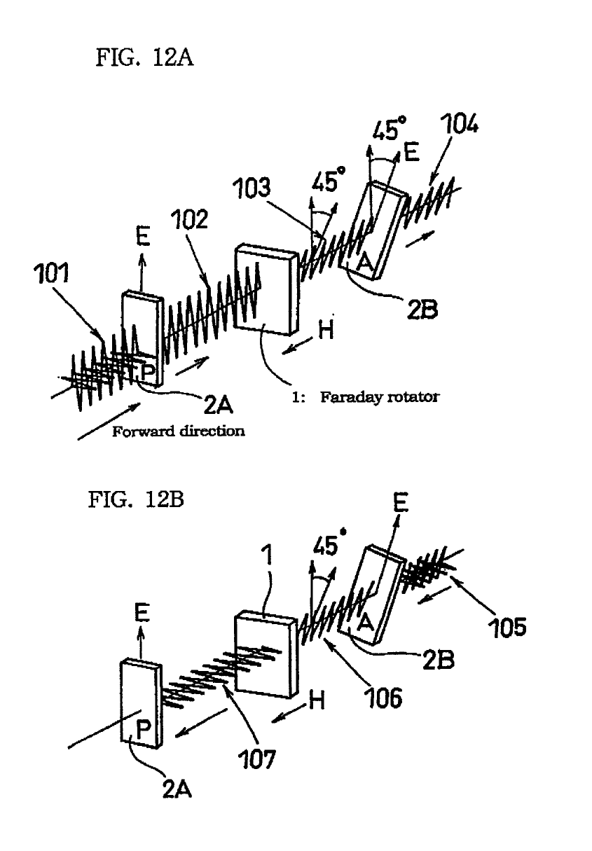

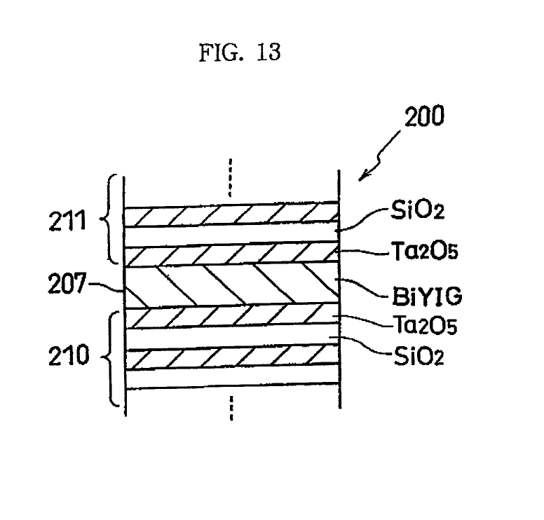

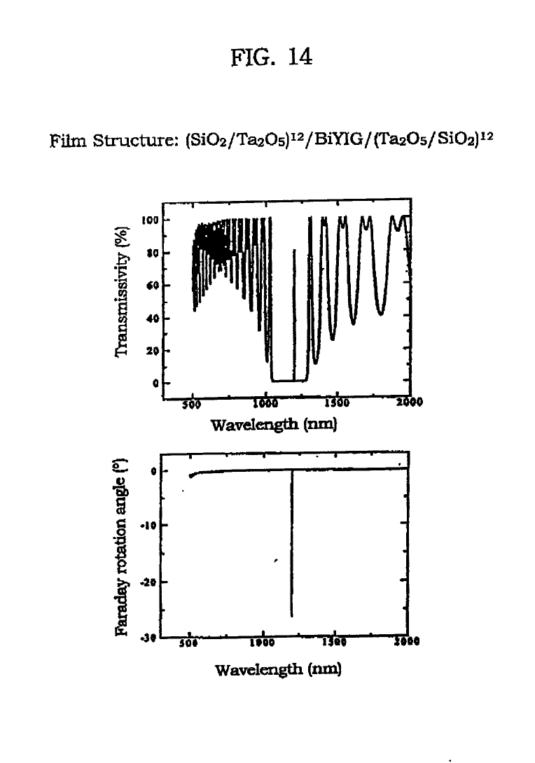

An optical isolator may be constructed as shown in FIG. 10 by using the above-mentioned magneto-optical body (third embodiment).

The optical isolator shown in FIG. 10 is general composed of a polarizer 32A, an analyzer 32B, the magneto-optical body 300 (Faraday rotor, magneto-optical element) that is provided between the polarizer 32A and the analyzer 32B and rotates the plane of polarization of light by 45 degrees, and permanent magnets 33 to apply a magnetic field.

In the third embodiment, the magneto-optical body 300 has the dielectric multilayered films 310, 311 each comprising the two kinds of dielectric thin films (Si film 320 and SiO₂ film 321 (see FIG. 1)) having refractive indexes largely different from each other as described above. So, light is localized more strongly at the center thereof and provides a high magneto-optical effect. Additionally, a large Faraday rotation angle is obtained with a small number of layers of the dielectric thin films.

Moreover, since a large Faraday rotation ante can be obtained with a reduced number of the layers of the dielectric thin films in the magneto optical body 300, a manufacturing cost may be reduced, and since process control is relatively easy, a manufacturing yield may improve. Accordingly, the optical isolator of the third embodiment (FIG. 10) using the magneto-optical body 300 has improved characteristics and manufacturing yield.

According to the first to third aspects of the present invention, by forming two dielectric multilayered films each comprising two types of dielectric thin films having a refractive index largely different from each other, light is more strongly localized at he center of a magneto-optical body, and a higher magneto-optical effect may be obtained. Additionally, a large Faraday rotation angle may be obtained with a reduced number of layers of the dielectric thin films, thus reducing a manufacturing cost. Moreover, process control is relatively easy, thus improving a manufacturing yield.

According to the fourth aspect of the present invention, since the number of layers of dielectric thin films may be reduced, the manufacturing cost of a magneto-optical body is reduced, and process control also is relatively easy, thereby improving a manufacturing yield. Therefore, an optical isolator using the magneto-optical boxy has better characteristics and a higher manufacturing yield.

What is claimed is:

1. A magneto optical body comprising:
two dielectric multilayered films in each of which two types of dielectric thin films having different optical characteristics from each other are alternately laminated with each thereof regular in thickness, and
a magnetic thin film provided between the two dielectric multilayered films;
wherein one dielectric thin film of the two types has a refractive index different from a refractive index of other dielectric thin film.

2. The magneto-optical body according to claim 1, wherein the one dielectric thin film has a refractive index of three or higher, and the other dielectric thin film has a refractive index of less than three.

3. The magneto-optical body according to claim 1 or 2, wherein the one dielectric thin film is Si, and the other dielectric thin film is SiO₂.

4. An optical isolator comprising the magneto-optical body according to any one of claims 1 to 3.
